(19) United States
(12) Patent Application Publication
(10) Pub. No.: US 2003/0120533 A1
(43) Pub. Date: Jun. 26, 2003

(54) Systems and methods for increasing business productivity and revenues by identifying critical interactions relating to customers

(75) Inventors: Richard J. Popillo, Raleigh, NC (US); Karla D. Mizelle, Raleigh, NC (US); Gary H. Strawbridge, Raleigh, NC (US); Kenneth G. Curtis III, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC

(21) Appl. No.: 10/036,801

(22) Filed: Dec. 21, 2001

(51) Int. Cl. G06F 17/60

(52) U.S. Cl. 705/9

(57) ABSTRACT

Systems and techniques are described for increasing business productivity and customer satisfaction. One technique includes identifying and making an inventory of touchpoints, and identifying and validating projects, based upon the inventory of touchpoints. The projects are then prioritized based on an analysis of critical customer requirements and overall financial impact, and rigorously executed. The technique further includes measuring increases in productivity and customer satisfaction.

### BACKGROUND OF THE INVENTION

The present invention relates generally to improvements to systems and methods for increasing business productivity and revenues, and more particularly to advantageous aspects of systems and methods for increasing business productivity and revenues by identifying critical interactions relating to customers.

Currently, business organizations typically do not have integrated, digitized systems for monitoring and redesigning customer-related interactions. The lack of such systems can lead to inefficiencies, including the duplication of efforts by employees, the allocation of marketing resources to low-priority projects and tasks, and the failure to recognize and accord proper priority to certain critical interactions relating to customers.

### SUMMARY OF THE INVENTION

The above-described issues and others are addressed by the present invention, aspects of which provides systems and techniques for analyzing and redesigning interactions between a business organization and a customer. One aspect of the invention provides a method comprising identifying and making an inventory of touchpoints. The method further comprises identifying and validating projects, based upon the inventory of touchpoints. The projects are then prioritized based on an analysis of critical customer requirements and overall financial impact, and rigorously executed. The method further includes measuring increases in productivity and customer satisfaction.

Additional features and advantages of the present invention will become apparent by reference to the following detailed description and accompanying drawings.

### BRIEF DESCRIPTION OF THE DRAWINGS

FIG. 1 shows a flowchart of a method according to an aspect of the invention for increasing business productivity and customer satisfaction by analyzing and redesigning interactions between a business organization and its customers.

FIG. 2 shows a table listing core processes identified by a business organization and employees of the business organization who have been designated to be core process owners.

FIG. 3 shows a flow diagram illustrating how projects are identified and prioritized in accordance with an aspect of the invention.

FIG. 4 shows a flow diagram illustrating the concept of a touchpoint.

FIG. 5 shows an exemplary touchpoint catalogue.

FIG. 6 shows a table setting forth business models and business goals for a portion of the business organization's customer base, segmented according to mode of distribution.

FIG. 7 shows an exemplary list of projects that have been generated based upon a touchpoint analysis.

FIG. 8 shows a table illustrating how projects are validated against top level indicators based upon critical customer needs.

FIG. 9 shows a high-priority matrix used to assign relative priorities to potential projects.

FIG. 10 shows a list of potential projects ranked according to priority.

FIG. 11 shows a diagram of a web-based system, according to a further aspect of the invention, for analyzing and redesigning interactions between a business organization and a customer.

FIG. 12 shows a basic main menu screen according to an aspect of the invention.

FIG. 13 shows a full main menu screen according to an aspect of the invention.

FIG. 14 shows a project list screen according to an aspect of the invention.

FIG. 15 shows a project e-audit summary screen according to an aspect of the invention.

FIG. 16 shows a basic data screen according to an aspect of the invention.

FIG. 17 shows a core process drilldown screen according to an aspect of the invention.

FIG. 18 shows a drilldown screen for an individual core process according to an aspect of the invention.

FIG. 19 shows a basic data screen accessed from the drilldown screen shown in FIG. 18, according to an aspect of the invention.

FIG. 20 shows a team data screen according to an aspect of the invention.

FIG. 21 shows a process data screen according to an aspect of the invention.

FIG. 22 shows a touchpoint data screen according to an aspect of the invention.

FIG. 23 shows a finance/FTE summary screen according to an aspect of the invention.

FIG. 24 shows a tollgate review data screen according to an aspect of the invention.

FIG. 25 shows a marketing data screen according to an aspect of the invention.

FIG. 26 shows an e-commercialization data screen according to an aspect of the invention.

FIG. 27 shows a project financial impact summary screen according to an aspect of the invention.

FIG. 28 shows a project summary screen according to an aspect of the invention.

FIG. 29 shows an expense/FTE summary screen for an individual core process according to an aspect of the invention.

FIG. 30 shows an expense/FTE summary screen for multiple core processes according to an aspect of the invention.

FIG. 31 shows a marketing project summary screen according to an aspect of the invention.

FIG. 32 shows a touchpoints screen for all core processes according to an aspect of the invention.

FIG. 33 shows a project delivery schedule screen according to an aspect of the invention.

FIG. 34 shows a project tollgate review screen according to an aspect of the invention.

FIG. 35 shows a team member maintenance screen according to an aspect of the invention.

FIG. 36 shows a finance history data screen according to an aspect of the invention.

FIG. 37 shows a core process list screen according to an aspect of the invention.

FIG. 38 shows a top level indicators screen according to an aspect of the invention.

FIG. 39 shows a customer title list screen according to an aspect of the invention.

FIG. 40 shows a system parameters screen according to an aspect of the invention.

FIG. 41 shows a process step list screen according to an aspect of the invention.

### DETAILED DESCRIPTION

As used herein, the term “core processes” refers to processes performed by a business organization that have been identified as creating added value for the business organization or its customers.

As used herein, the term “core process owner” or “CPO” refers to an employee of a business organization who, in accordance with an aspect of the invention, has been designated to be accountable for the successful application of the e-Make™ system to a specified core process.

As used herein, the term “critical to quality” or “CTQ” refers to customer needs, the satisfaction of which a business organization has identified as being critical to the quality of service received by the customer.

As used herein, the term “digitize” refers to the process of redesigning a touchpoint to be web-enabled, or otherwise automated. Thus, for example, a touchpoint that has heretofore been conducted as a telephone request from a customer to a company employee is said to be digitized if that touchpoint can now be accomplished by the customer logging onto a website and receiving an automatic response to the request.

As used herein, the term “drilldown” refers to movement down to the next level of detail in a set of data. A drilldown may move down through several levels of detail.

As used herein, the term “e-Blitz™” refers to a proprietary database system that is used as a central repository for storing detailed information for projects identified as part of the e-Make™ system, and is also used as a real-time reporting mechanism for project teams and management.

As used herein, the term “e-DMADV™” refers to a proprietary project management system used to provide step-by-step tools for defining objectives, customers, potential issues, and the like. The term “e-DMADV™” is an acronym that includes a lowercase “e” for “electronic” and five uppercase letters representing five steps in the system: Define Measure, Analyze, Design, and Verify.

As used herein, the term “e-Make™” generally refers to systems and methods according to various aspects of the invention.

As used herein, the term “process control system” or “PCS” refers to a system used to examine and monitor the e-Make™ system.

As used herein, the term “touchpoint” refers to critical interactions between a business organization and a customer and to critical interactions within the business organization relating to the customer. The term “external touchpoint” refers to interactions between the business organization and the customer. The term “internal touchpoint” refers to interactions within the business organization relating to the customer.

In today's highly competitive business world, it is increasingly important for a business organization to maximize its productivity and revenues. One important component of a business's activities is how well it conducts and manages customer-related interactions. These interactions include both interactions between the business organization and the customer, and interactions within the business organization relating to the customer. In order to maximize productivity and revenues, it is desirable for these customer-related interactions to be conducted in as efficient and orderly a manner as possible, to avoid unnecessary or duplicative interactions and to minimize or eliminate time delays.

Aspects of the present invention provide systems and methods, generally referred to herein as “e-Make™,” by which an organization can identify critical internal and external interactions relating to customers. These critical interactions are called “touchpoints.” Once touchpoints have been identified, they are analyzed to determine whether certain touchpoints may be redesigned or eliminated. After the touchpoints have been identified and analyzed, they are then catalogued. Specific projects are identified, prioritized, and staffed. According to a further aspect of the invention, the invention may be designed to work in conjunction with tools already existing within the organization, including quality assurance programs, process control charts, and spreadsheet programs.

A further aspect of the invention includes the integration of the e-Make™ system with a project management system that provides step-by-step tools for defining objectives, customers, potential issues, and the like. The project management system is called “e-DMADV™,” which is an acronym including the letter “e” for “electronic” and the remaining letters relating to five steps in the system: define, measure, analyze, design, and verify. These five steps are tracked within the database to report progress.

Aspects of the present invention are described herein as relating to a mortgage insurance company and to e-commerce. However, it should be noted that it would be possible to modify the invention for use in any of a number of different business settings without departing from the spirit of the invention.

Mortgage insurance is a type of insurance that insures a mortgagee, such as a bank or other lending institution, against certain specified losses resulting from a default by a borrower-mortgagor. In today's real estate market, in which it is often possible for a purchaser of real estate to obtain financing with little or no down payment, the use of mortgage insurance is becoming increasingly common.

From the point of view of a mortgage insurance underwriter, customers include banks, savings and loans, mortgage companies, and other mortgage lenders. The mortgage insurance business is a competitive one, with significant cost and pricing pressures. This means that a mortgage insurance company must generate a high volume of business to be profitable. In addition, there are barriers to entry for competition based upon the capital requirements necessary to cover the risk that is being insured. Thus, a mortgage insurance company must find creative ways to distinguish itself from its competitors. One such way is to develop systems, such as the present invention, which allow the mortgage insurance company to better meet the needs of their customers, while cutting costs.

Thus, the strategies underlying the present invention include the following. One strategy, mentioned above, is the identification of touchpoints, that is, critical exchanges of data between customers and other internal functions. If these touchpoints are properly identified, analyzed, and redesigned, as described below, they may be used as the basis of projects leading to enhanced customer fulfillment, and potential increased revenues both for customers and for the mortgage insurance company. This in turn may serve to differentiate the mortgage insurance company from its competitors while cutting costs.

According to an aspect of the invention, certain employees of the business organization are designated to be “core process owners” (CPOs). CPOs function as e-business executors, and are accountable for the successful application of the e-Make™ system to core processes. CPOs work to identify and catalog all touchpoints. Once the touchpoints have been identified and catalogued, they can then be redesigned with an eye to maximizing the insurance company's resources. As part of the redesign process, certain touchpoints may be found to be unnecessary or duplicative, and can be eliminated. Other touchpoints may be redesigned by digitizing them. Digitized touchpoints can be made available for use by other aspects of the e-Make™ system or by other software applications.

According to an aspect of the invention, a high quality infrastructure is used to drive e-Make™. As described below, an aspect of the invention includes process control systems (PCSs) to find touchpoints, and a networked database tool called “e-DMADV™” to facilitate the redesign of touchpoints. As mentioned above, e-DMADV™ is an acronym including the letter “e” for “electronic” and the remaining letters relating to five steps in the system: define, measure, analyze, design, and verify.

The execution of prioritized projects includes three steps. First, a project structure is created by a core process owner (CPO) using the e-DMADV™ tool. Second, project charters are developed. Third, the projects are managed to completion.

During the define, measure, and analyze phases, an aggressive project plan is set up. In order for a project to proceed, it must be demonstrated to the CPO that the project will result in lowered costs, incremental revenue, and increased customer satisfaction. Thus, each of the three phases provides an opportunity to kill a project, prior to the fourth and fifth phases of the e-DMADV™ tool. A general philosophy of the e-DMADV™ tool is to kill a project early, or drive the project aggressively.

In the design phase, a final cost/benefit analysis is performed. As part of this cost/benefit analysis, the impact of the project is quantified across all functions, and cross-functional “tollgates” are constructed. In the verify phase, all loops are closed. These loops include training, job changes, and new/revised indicators. Also, revenue flows are assured, as well as “credit to cash.”

In addition to infrastructure, it is contemplated that e-Make™ will require rigorous discipline on the part of employees using the system. This discipline includes such matters as project status and reducing internal expenses by eliminating/reducing touchpoints, thereby working to improve customer fulfillment. According to a further aspect of the invention, once touchpoints have been identified, cataloged, and redesigned, they can be digitized. Once they have been digitized, touchpoints can be used in conjunction with existing quality assurance systems, such at the “Six Sigma” system.

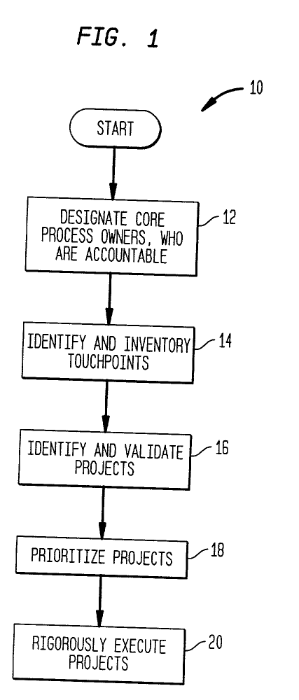

The above points are illustrated in FIG. 1, which shows a flowchart of a method 10 according to an aspect of the e-Make™ system. In step 12, core process owners (CPOs) are designated by a business organization. As mentioned above, the CPOs are accountable for the successful application of the e-Make™ system to identified core processes. In step 14, touchpoints are identified and inventoried for each core process. In step 16, projects are then identified and validated. The goal of these projects is to eliminate, redesign or web-enable identified touchpoints. In step 18, the projects that have been identified and validated are then prioritized. In step 20, the projects are then rigorously executed according to their relative priorities.

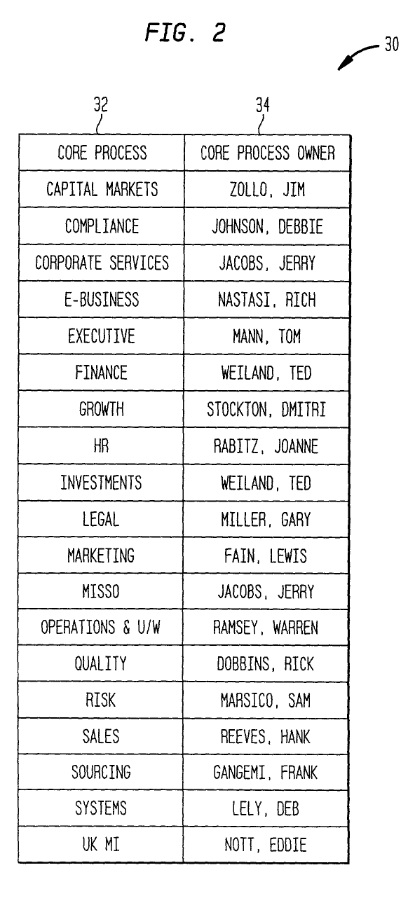

FIG. 2 shows an exemplary core process table 30. The first column of the table 30 lists core processes 32 that have been identified by a business organization. The second column of the table 30 lists core process owners (CPOs) 34, who have designated by the business organization to be accountable for the successful application of the e-Make™ system to the core processes 32. As is apparent from FIG. 2, the same person may be assigned to be a CPO for more than one core process. It should be noted that the list of core processes may vary from business organization to business organization without departing from the spirit of the present invention.

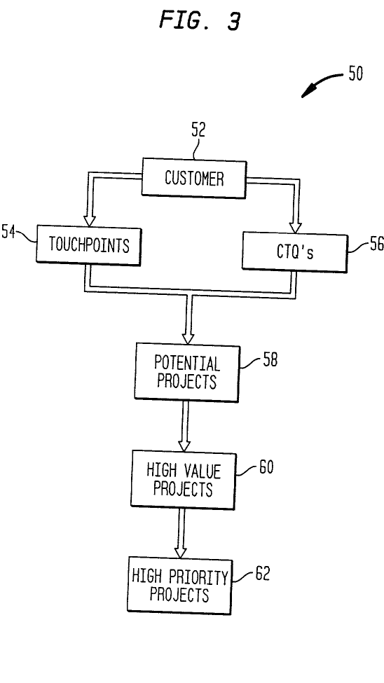

The designated CPOs are accountable for the application of the e-Make™ system to their respective core processes. FIG. 3 shows a flow diagram 50 illustrating the operation of the e-Make™ system, according to an aspect of the invention. As shown in FIG. 3, the process begins with customer analysis 52. From this analysis, touchpoints 54 and CTQs 56 are identified. Based upon the identified touchpoints and CTQs, a list of potential projects 58 is developed. From this list, a determination is made as to which projects are high value 60, and from the list of high-value projects, a determination is made as to which projects are high-priority 62. Thus, as illustrated in FIG. 3, applying the e-Make™ system leads to the creation of a list of high-value, high-priority projects on which a business organization may effectively concentrate its resources.

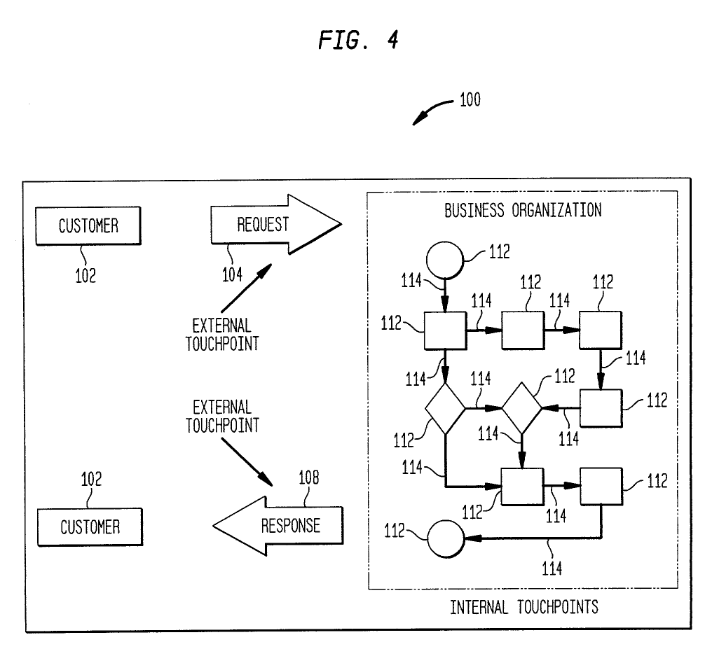

FIG. 4 is flow diagram 100 illustrating the concept of a touchpoint. The flow diagram 100 includes a customer 102 and a business organization 106. The business organization 106 includes a number of sub-units 112, which can be, for example, employees or larger functional units within the organization. It will be recalled from the above discussion that a touchpoint is an exchange of data or information. As shown in FIG. 4, this exchange can take a number of different forms, including, for example, a request 104 from a customer 102 to the business organization 106, or a response from the business organization 106 to the customer 102. These exchanges between a customer 102 and the business organization 106 are referred to as “external touchpoints.” As further illustrated in FIG. 4, exchanges of data 114 may also occur between sub-units 112 within the business organization. These exchanges between business sub-units 112 are referred to as “internal touchpoints.” As mentioned above, according to an aspect of the invention, the identification and redesign of touchpoints 104, 108, 114, including the elimination of unnecessary or duplicative touchpoints, are used to eliminate costs, decrease defects, and decrease the amount of time required for interactions with customers.

According to a further aspect of the invention, guidelines are provided for compiling a touchpoint inventory including, for example, the creation of a separate sheet for each core process. A touchpoint includes events or actions in which a customer or a business organization provides or exchanges data or information. Touchpoints include actions and events both at the beginning and at the end of a process. Thus, each process includes at least two touchpoints, one initiating the process and the other completing the process. In addition, touchpoints include any interchanges of data or information that take place during a process. These interchanges include, for example, telephone calls, each of which is considered to be a single touchpoint.

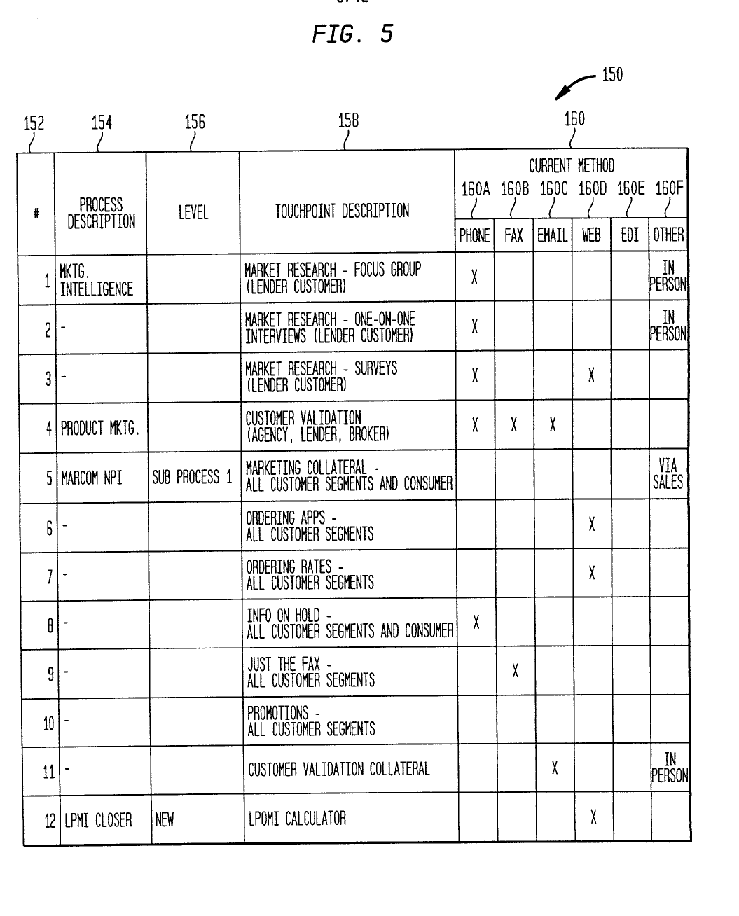

FIG. 5 shows a table setting forth an exemplary touchpoint catalog 150 according to an aspect of the present invention. As shown in FIG. 5, the touchpoint catalog 150 includes the following columns: identifying number 152, process description 154, level 156, touchpoint description 158, and current method 160 used to implement the touchpoint. As further shown in FIG. 5, the touchpoint catalog 150 includes the following interaction methods: telephone 160a, facsimile 160b, e-mail 160c, web 160d, EDI 160e, and other 160f. It will be apparent that the touchpoint catalog 150 shown in FIG. 5 may be modified, as desired, without departing from the spirit of the present invention. For example, different or additional columns may be used, or certain columns may be combined.

According to a further aspect of the invention, it is contemplated that the e-Make™ system will be used in conjunction with a process control system (PCS) that is used to examine and monitor the process. This PCS may be a system that is already in use within a business organization. Thus, in the touchpoint catalog 150 shown in FIG. 5, it is contemplated that the process description 154 and the level 156 will be the same as the corresponding process description and level used in conjunction with the PCS. It should be noted that, in addition to already existing touchpoints, the touchpoint inventory includes new touchpoints that will be created through the execution of additional projects.

An already existing process control system (PCS) can be used in the identification of touchpoints. However, as described herein, the e-Make™ system allows touchpoint information to be expanded to include other types of data, including, for example, the method of submission, such as by telephone, facsimile, and the like. One reason that this is significant is that touchpoints may be executed using various methods, including those listed in the current method column 160 shown in FIG. 5: telephone, facsimile, e-mail, web, EDI, or other. Each of these methods has different associated costs.

In addition, the e-Make™ system allows touchpoint information to be expanded to include frequency information. One way of quantifying touchpoint frequency is number of touches per year. Touchpoint frequency is an area of opportunity. In particular, touchpoint frequency information allows a business organization to redesign touchpoints in an intelligent manner. However, more than merely counting touchpoints, the e-Make™ system allows touchpoints to be digitized, as described further below. As mentioned above, the digitization of touchpoints allows the e-Make™ system to be used in conjunction with already existing quality control systems.

As mentioned above, a further aspect of the e-Make™ system includes an analysis of the business organization's customers. In particular, an effort is made to understand customer segmentation and customer needs by identifying customer needs that are critical to quality (CTQ) and by analyzing research data. This customer analysis is used to prioritize projects that have been identified based upon the touchpoint inventory. An underlying assumption of the customer analysis is that customers want the business organization to help them increase profits by increasing productivity and revenue.

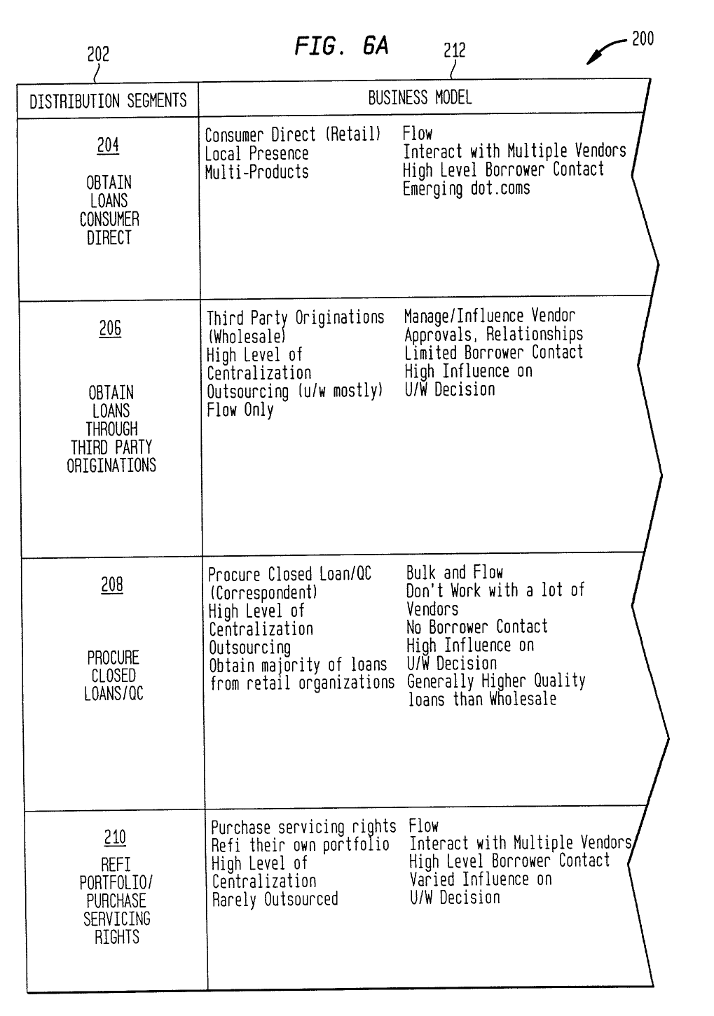

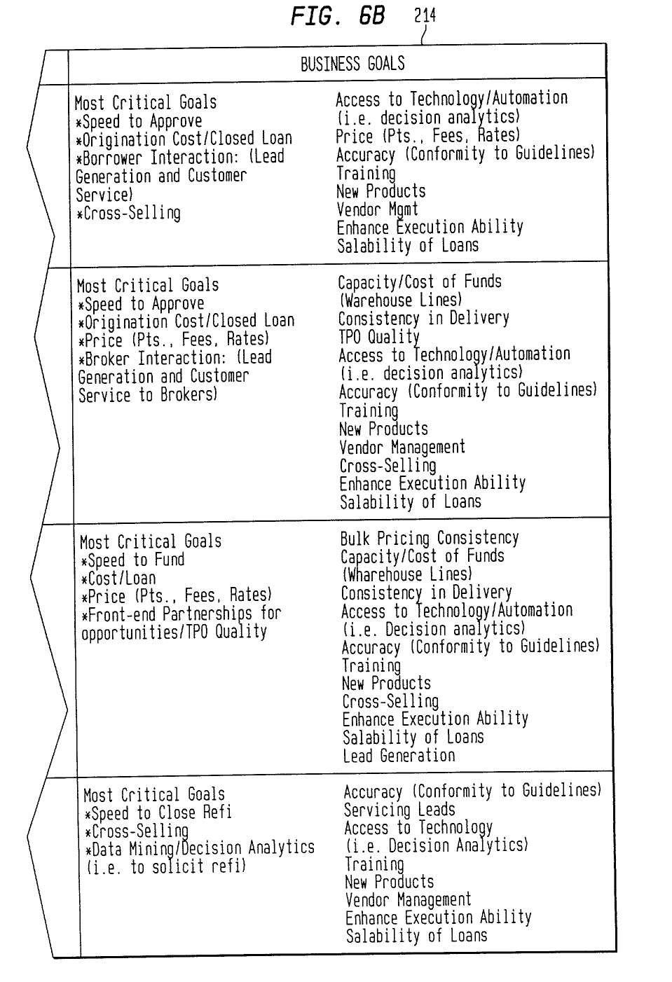

FIG. 6 shows a table 200 illustrating an exemplary analysis, according to an aspect of the invention, of a portion of a mortgage insurance company's customer base that includes large, well-capitalized national lending institutions (“nationals”). In table 200, this portion of the customer base has been segmented according to modes of distribution.

The first column 202 of the table 200 shown in FIG. 6 lists four distribution segments: “obtain loans consumer direct” 204; “obtain loans through third-party originations” 206; “procure closed loans/QC” 208; and “refinance portfolio/purchase service rights” 210. The second column 212 of the table 200 lists business model components associated with each distribution segment 204-210. The third column 214 of the table 200 includes business goals associated with each distribution segment 204-210.

As shown in FIG. 6, for customers in the first business segment 204, “obtain loans consumer direct,” the business model includes the following components: retail marketing directly to consumers; local presence; multi-products; flow; interaction with multiple vendors; high-level borrower contact; and emerging dot.coms. Business goals for the first business segment 204 include the following: speed of approval; origination cost/closed loan; borrower interaction, including lead generation and customer service; and cross-selling. Other goals for this segment 204 include: access to technology/automation, such as decision analytics; price, including points, fees, and rates; accuracy, including conformity to guidelines; training; new products; vendor management; entrance execution ability; and saleability of loans.

For customers in the second segment 206, “obtain loans through third-party originations,” the business model 212 includes the following components: wholesale marketing to third-party loan originators; high level of centralization; outsourcing, mostly to underwriters; flow only; management/influence of vendor approvals, relationship; limited borrower contact; high influence on the underwriting decision. Business goals for the second segment 36 include the following: speed of approval; origination cost/closed loan; price, including points, fees, and rates; and broker interaction, including lead generation and customer service to brokers. Other goals include: capacity/cost of funds, including warehouse lines; consistency in delivery; TPO quality; access to technology/automation, such as decision analytics; accuracy, including conformity to guidelines; training, new products; vendor management; cross-selling; the enhancement of execution ability; and the saleability of loans.

For customers in the third segment 208, “procure closed loans/quality control (QC),” the business model 212 includes the following components: procuring closed loans/QC from correspondents; high level of centralization; outsourcing; obtaining a majority of loans from retail organizations; bulk and flow; not working with a lot of vendors; no borrower contact; high influence on underwriting decision; and generally higher quality loans than loans obtained from the wholesale market. Business goals 214 for the third segment 208 include the following: speed to fund; cost per loan; price, including points, fees, and rates; and front-end partnerships for opportunities/TPO quality. Other goals include: bulk pricing consistency; capacity/cost of funds, such as warehouse lines; consistency in delivery; access to technology/automation, such as decision analytics; accuracy, including conformity to guidelines; training; new products; cross-selling; enhance execution ability; saleability of loans; and lead generation.

For customers in the fourth segment 210, “refinance portfolio/purchase servicing rights,” the business model 212 includes the following components: purchasing of servicing rights from customers; high level of centralization; rate outsourcing; flow; interaction with multiple vendors; high-level borrower contact; and varied influence on the underwriting decision. Business goals for the fourth segment 210 include the following: speed to close refinancing; cross-selling; data mining/decision analytics to solicit refinancing. Other goals include: accuracy, including conformity to guidelines; servicing leads; access to technology/automation, such as decision analytics; training; new products; vendor management; enhancement or execution ability; and saleability of loans.

For the four distribution segments illustrated in FIG. 6 and discussed above, the following CTQs may be defined. CTQs for the first distribution segment 204, “Obtain Loans, Customer Direct,” include: speed to approve; origination cost and closed loan; borrower interaction; and cross-selling. CTQs for the second segment 206, “Obtain Loans through Third-Party Originations,” include: speed to approve; origination cost and closed loan; price, including points, fees, and rates; and broker interaction/TPO quality. CTQs for the third segment 208, “Procure Closed Loans/QC,” include: speed to approve; cost per loan; price; and partnerships/TPO quality. CTQs for the fourth segment 210, “Refinance Portfolio/Purchase Servicing Rights,” include: cost effectiveness; speed to close refinancing; cross selling; and data mining/decision analytics.

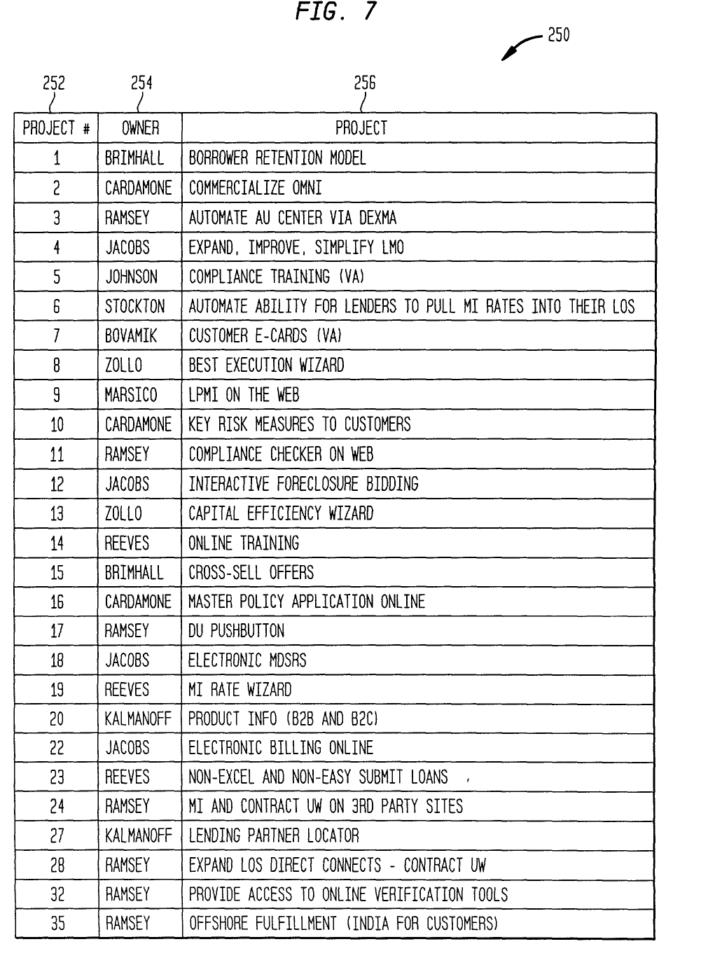

At this point in the e-Make™ system, specific projects are identified and validated. FIG. 7 shows a table containing an exemplary project list 250, according to an aspect of the invention. As shown in FIG. 7, the project list 250 includes a project number 252, a project owner 254, and a project description 256. Project ideas are gathered, based upon a touchpoint catalog, such as the catalog 150 illustrated in FIG. 5. The proposed projects are then validated against customer CTQs identified in a customer analysis, such as the analysis 200 illustrated in FIG. 6. CTQs may include, for example, speed, revenue, cost per loan and the like. Proposed projects are also validated against value-added indicators, including, for example, differentiation from competitors and requests from customers.

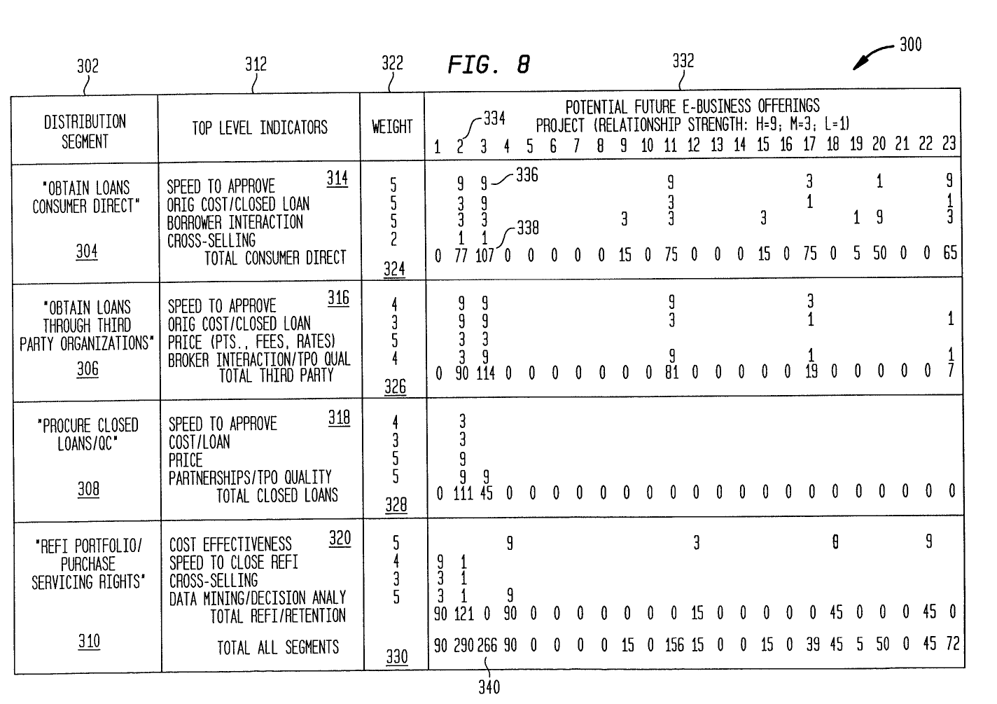

FIG. 8 shows a table 300 illustrating the validation of proposed project ideas against CTQs. The table 300 includes a first column 302 setting forth previously identified customer segments 304-310. A second column 312 includes entries for each customer segment identifying top-level CTQ indicators 314-320 for that customer segment. A third column 322 assigns weights 324-330 to each CTQ 314-320 in the second column 312. A fourth column 332 lists proposed projects identified by number 334. Each proposed project 334 is then analyzed by assigning a relationship strength 336 of that project to each CTQ indicator set forth in the second column 356. The relationship strengths 336 are then multiplied with the weights 324-330 in the third column 322. The resulting products are then added to produce a subtotal 338 for each distribution segment 304-310. Finally, the subtotals 338 are added together to arrive at a grand total 340 for each project 334. This grand total 340 can then be used as a quantitative basis for comparing various projects. According to a further aspect of the invention, a second table can be used in which the projects are validated against value-added indicators.

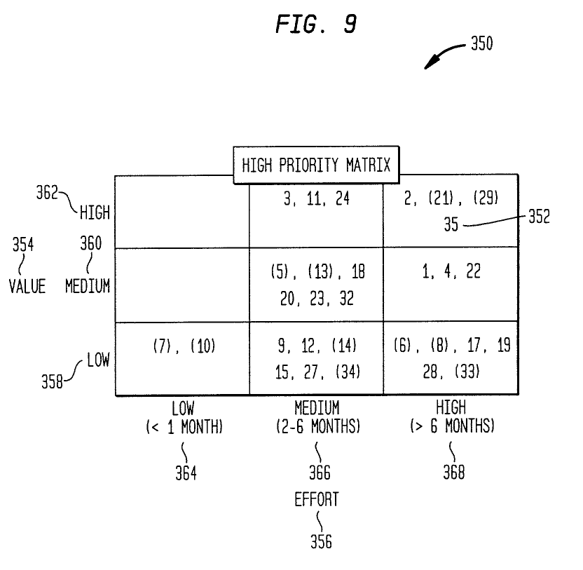

Once the various proposed projects have been assigned scores, a determination is made as to the relative effort required to implement each project. One way of measuring the relative effort is by estimating the number of months required to complete the project. After the relative effort for each proposed project has been quantified, each project can then be loaded into a matrix 350, such as the one shown in FIG. 9, according to the project's relative value 354 and effort 356. As shown in FIG. 9, each project is categorized according to three ranges of value 354: low 358, medium 360, and high 362. In addition, each project is categorized according to three ranges of effort 356: low, that is, less than one month; medium, that is, two to six months; and high, that is, more than six months. Once the projects have been prioritized using the matrix shown in FIG. 9, they can then be listed according to priority.

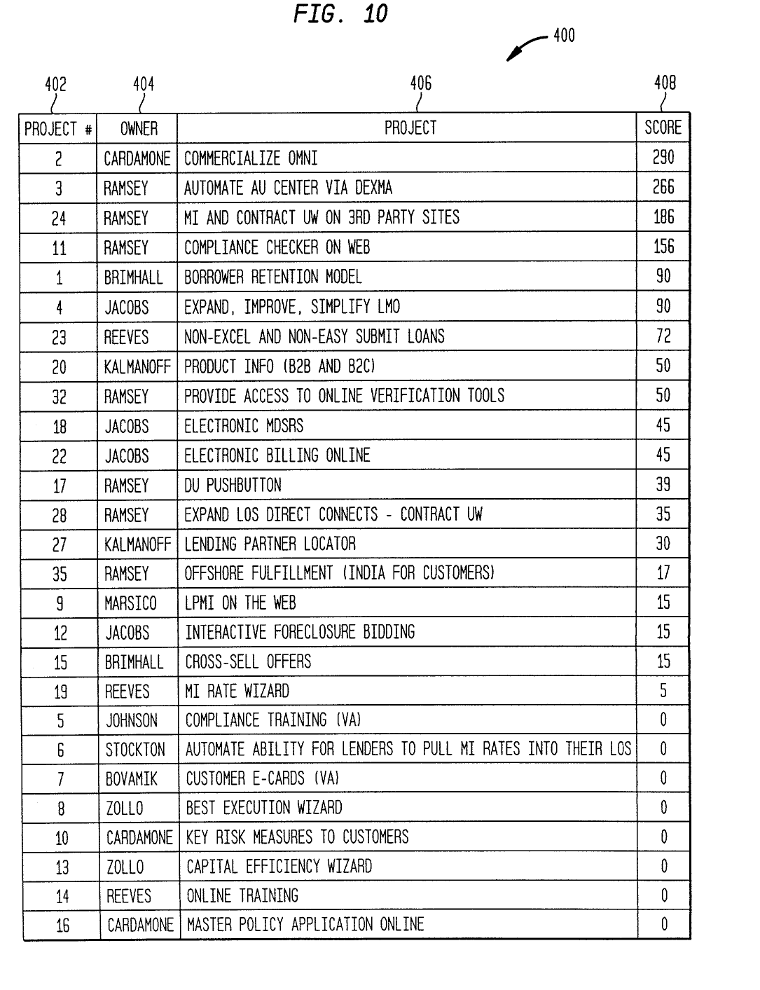

FIG. 10 shows a prioritized project list 400 reflecting the information contained in the matrix 350 shown in FIG. 9. As shown in FIG. 10, the prioritized project list 400 includes four columns. The first column 402 lists the project number; the second column 404 lists the project owner; the third column 406 lists the project description; and the fourth column 408 lists the score assigned to each project.

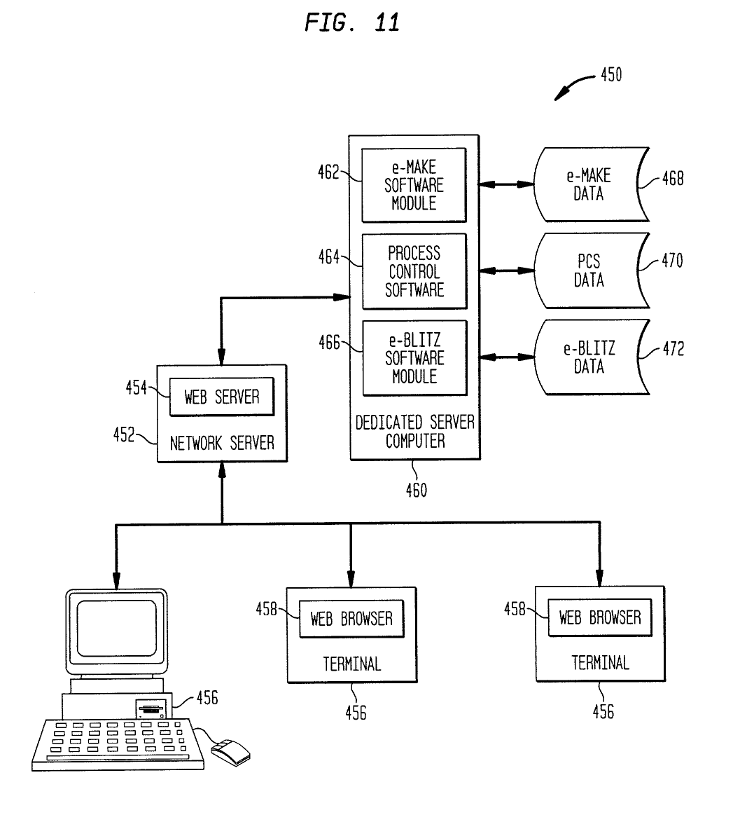

After the projects have been prioritized, the next step is the rigorous execution of the prioritized projects. As mentioned above, the e-Make™ system may be used in conjunction with an existing process control system (PCS). Further, the e-Make™ system may be implemented using a web-based network design. FIG. 11 shows a diagram of a web-based network 450 according to the present invention. As shown in FIG. 11, the network 450 is administered by a network server computer 452 running suitable web server software 454. The network server computer 452 is connected using an Internet connection or other suitable network connection to a network of terminals 456, each running suitable web browser software 458. The network server computer 452 is used to connect a dedicated server computer 460 into the network 450. The dedicated server computer 460 runs an e-Make™ software module 462, a process control software module (PCS) 464, and an e-Blitz™ software module 466. The dedicated server computer 460 has access to electronically stored data, including e-Make™ data 468, PCS data 470, and e-Blitz™ data 472. Network users can use the network 450 to access, update, or modify the e-Make™ data 468, PCS data 470, and e-Blitz™ data 472. It will be appreciated that the network 450 shown in FIG. 11 is illustrative, and that other configurations and devices may be used without departing from the spirit of the invention.

As mentioned above, the e-Blitz™ system is a database system according to an aspect of the invention that is used as a central repository for storing detailed information for projects identified in the e-Make™ system, and is also used as a real-time reporting mechanism for project teams and management. The e-Blitz™ system was developed using the database program Microsoft Access, and provides the following capabilities:

(1) capture details about a project, including team members, justification, schedules, marketing segments, touchpoint data, project status, and the like;

(2) drill down from a business summary level to a specific project;

(3) track detailed financial data; and

(4) provide summary reports by function, project leader, due date, and the like.

The e-Blitz™ system may be run locally or over a network, such as the network 450 illustrated in FIG. 11.

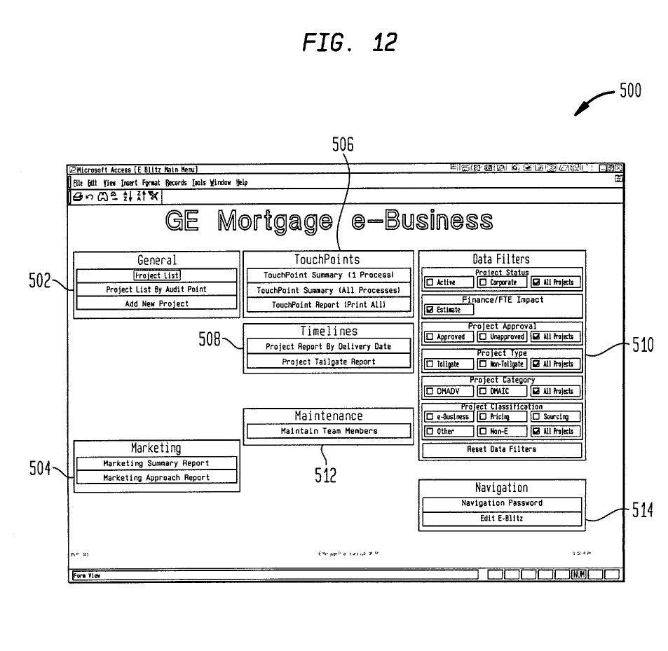

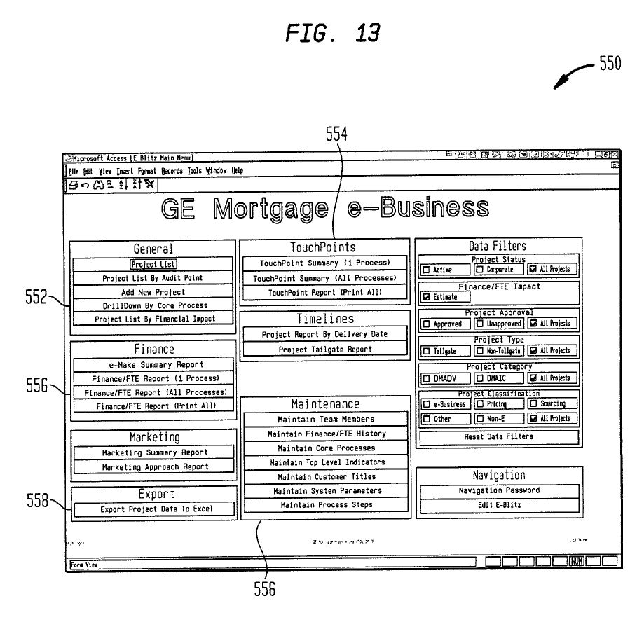

FIGS. 12 through 41 show screenshots of various screens that are displayed to a user of the e-Blitz™ system. FIG. 12 shows a basic home screen 500 and FIG. 13 shows a full main menu screen 500 for the e-Blitz™ system, according to an aspect of the invention. As mentioned above, the e-Blitz™ system facilitates the rigorous enforcement of e-Make™ projects by providing centralized access, on a website, to project management data. As described below, the e-Blitz™ system includes screens focusing on various aspects of the stored project data, as well as displaying data at varying levels of detail. In addition, an authorized user of the system may enter new project data into the e-Blitz™ system or modify data that has previously been entered into the system.

As shown in FIG. 12, the basic main menu screen 500 provides an authorized user with various menus allowing the user to access data, or perform other selected functions. The basic main menu screen 500 includes four menus for accessing various types of reports, lists, and other data: General 502, Marketing 504, TouchPoints 506, and Timeliness 508. The basic main menu screen 500 further includes a set of Data Filters 510, which allow the user to narrow the retrieved data according to various criteria, including: Project Status, Finance/FTE Impact, Finance Approval, Project Type, Project Category, and Project Classification. The basic main menu screen 500 further includes a Maintenance menu 512 and a Navigation menu 514.

The full main menu screen 550 shown in FIG. 13 is used by a system administrator or other authorized persons within the business organization. As shown in FIG. 13, the full main menu screen 550 contains all of the menus of the basis home screen 500. However, the General menu 552, the TouchPoints menu 554, and the Maintenance menu provide additional menu selections, allowing the user to perform additional functions. In addition, the full main menu screen 550 includes a Finance menu 556 and an Export menu 558.

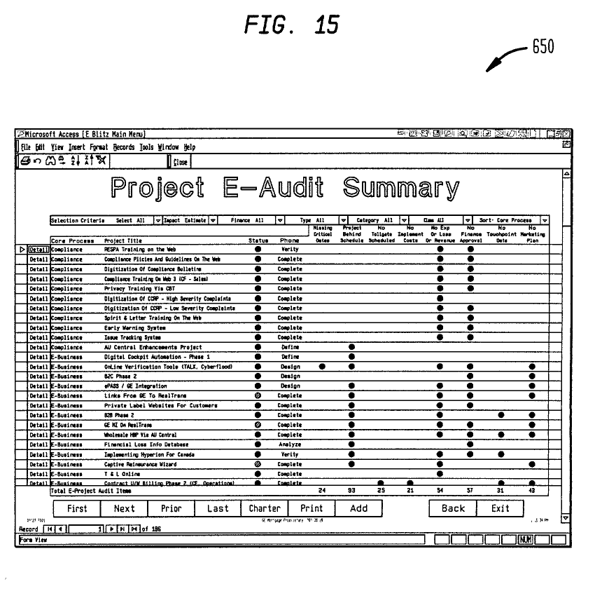

FIGS. 15 through 41 show e-Blitz™ screens that are accessible from the basic menu screen 500 shown in FIG. 12, and the full main menu screen 550 shown in FIG. 13. As set forth below, certain of the screens are only accessible from the full main menu screen 550. Also, certain of the screens are accessible directly from the basic or full main menu screen, while others are accessible through intermediate screens.

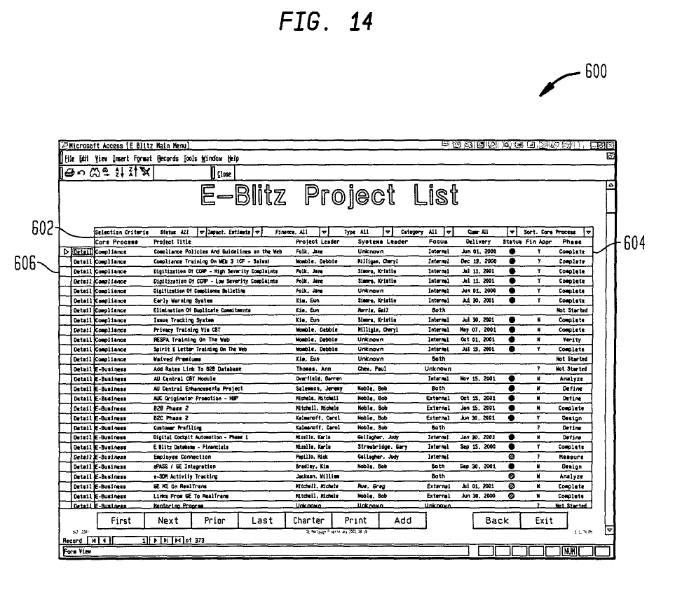

FIGS. 14 through 27 show screens that are accessible, directly or indirectly, by clicking on menu selections under the General heading on the main menu. The menu selections include the following: Project List; Project List by Audit Point; Add New Project; DrillDown by Core Process (full main menu screen only); and Project List by Financial Impact (full main menu screen only).

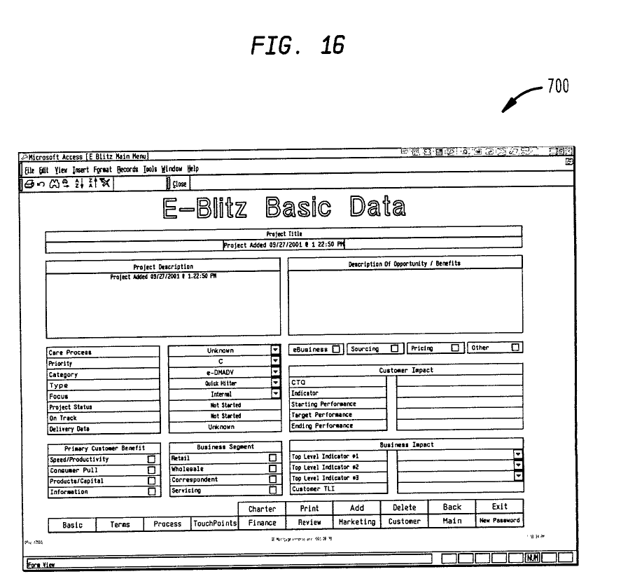

FIG. 14 shows a project list screen 600 according to an aspect of the invention. This screen is accessed by selecting Project List on the main menu. As shown in FIG. 14, the project list screen 600 lists projects identified as part of the e-Make™ system. The number of projects retrieved may be narrowed by using suitable Data Filters on either the basic home screen or the enhanced home screen. The Data Filters that have been applied appear in a bar 602 at the top of the list 604. For each project, the screen 600 lists: Project Title, Project Leader, Systems Leader, Focus, Delivery Date, Status, Finance Approval, and Phase. The user of the system may move to the next level of detail for a project by clicking on the Detail button 606 appearing at the left of the listed project. This will cause a basic data screen 700, such as the screen shown in FIG. 16, to be displayed.

FIG. 15 shows a project e-audit summary screen 650 according to an aspect of the invention. This screen is accessed by selecting Project List by Audit Point on the main menu. This screen 650 displays the e-Make™ project listed by audit points, including: Missing Critical Dates, Project Behind Schedule, No Tollgate Scheduled, No Implementation Costs, No Expense or Loss or Revenue, No Finance Approval, No Touchpoint Data, and No Marketing Plan. It will be appreciated that the project e-audit summary screen 650 is useful in quickly identifying projects stored in the system that require attention. Again, the user may retrieve additional data relating to a listed project by clicking on the Detail button at the left of the project. Doing so will cause a basic screen, such as the screen 700 shown in FIG. 16, to be displayed.

FIG. 16 shows a basic data screen 700 according to an aspect of the invention. This screen is accessed by selecting Add New Project on the main menu screen. The basic data screen 700 is used to add a new project into the system. As shown below, the template used for the basic data screen 700 is also used to display project data for projects that have already been entered into the system.

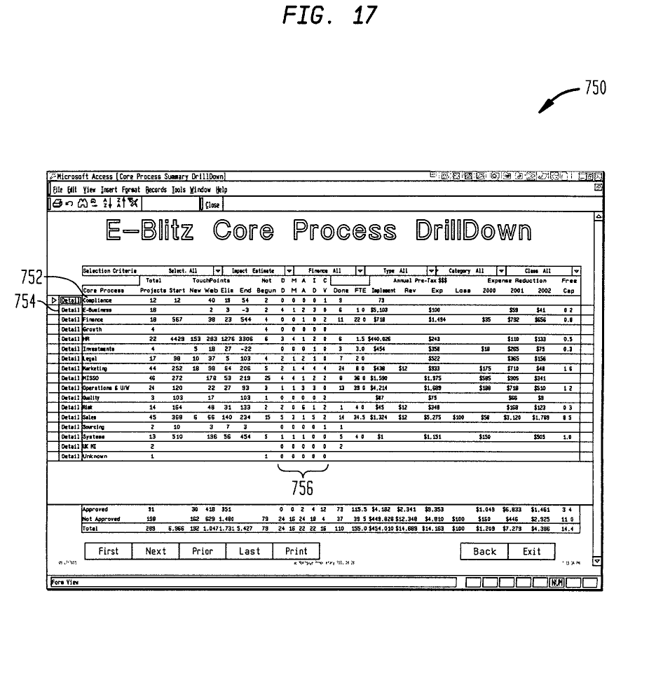

FIGS. 17 through 26 are a series of screens that are structured hierarchically to allow a user to access project management data at varying levels of detail. The screens include three basic levels of generality. The highest level of generality is the core process list level, which lists a business organization's core processes. The next level of detail is the project list level, which lists projects that have been identified for an individual core process. The third level of detail is the individual project level, which provides data for an individual project identified for a core process. As described below, each level may have a number of screens, focusing on various aspects of the data.

FIG. 17 shows a core process drilldown screen 750 that displays project management data at the highest level of generality, and that can be used as the starting point for a drilldown through the data. This screen 750 displays a list of core processes 752, together with a tabular summary of data relating to each listed core process. The user moves can move to a level of greater detail for each listed core process 752 by clicking on the Detail button 754 at the left of each listed core process 752.

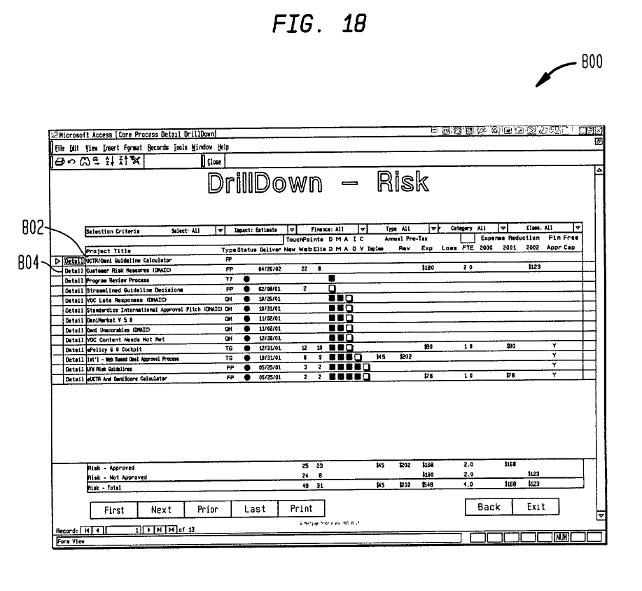

It will be seen that the core process drilldown screen 750 shown in FIG. 17 includes five columns labeled D, M, A, D, and V 756, corresponding to the five steps of the e-DMADV™ system described above: define, measure, analyze, design, and verify. By looking at the five DMADV columns 756 in FIG. 17, a user may quickly determine the general progress being made in completing the projects that have been identified to a particular core process. It will be seen that DMADV columns appear in other data screens, described below, including the screens shown in FIGS. 18, 27, 31, and 33.

FIG. 18 shows a drilldown screen 800 showing the next level of detail for an individual core process, namely, the Risk core process. As shown in FIG. 18, this screen 800 includes a list 802 of e-Make™ projects that have been identified for the Risk core process, and for each listed project, displays data including: Type, Status, Delivery Date, Touchpoints, and DMADV, as well as financial data. The user may move to the next level of detail for a given project by clicking on the Detail button 804 at the left of the project.

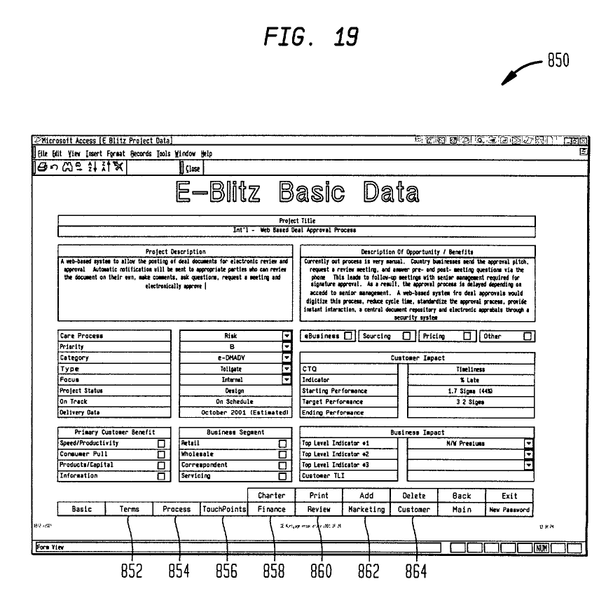

FIG. 19 shows a basic data screen 850 that is displayed for a project when a user has clicked on the Detail button 804 for that project on the drilldown screen 800 shown in FIG. 18. FIG. 19 shows basic data for a project entitled “International—Web Based Deal Approval Process.” As mentioned above, the basic data screen 850 for a project may also be accessed through the project list screen 600 shown in FIG. 14 or the e-audit summary screen 650 shown in FIG. 15.

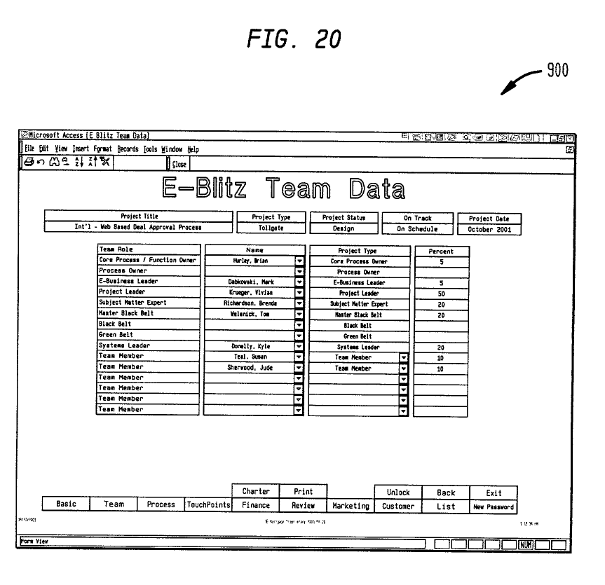

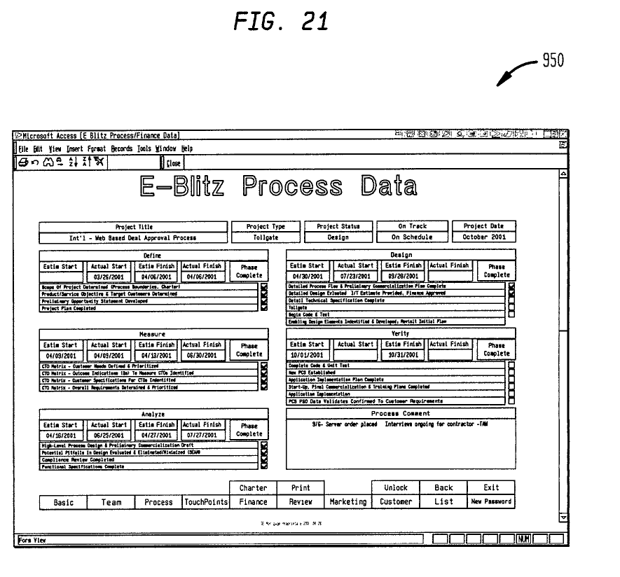

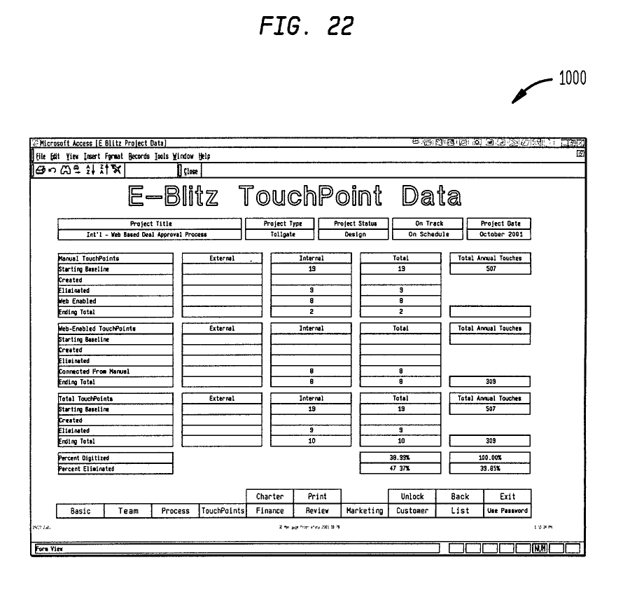

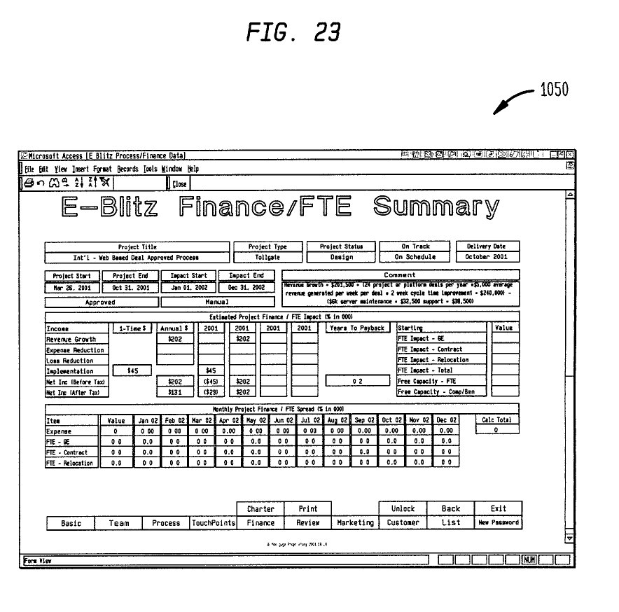

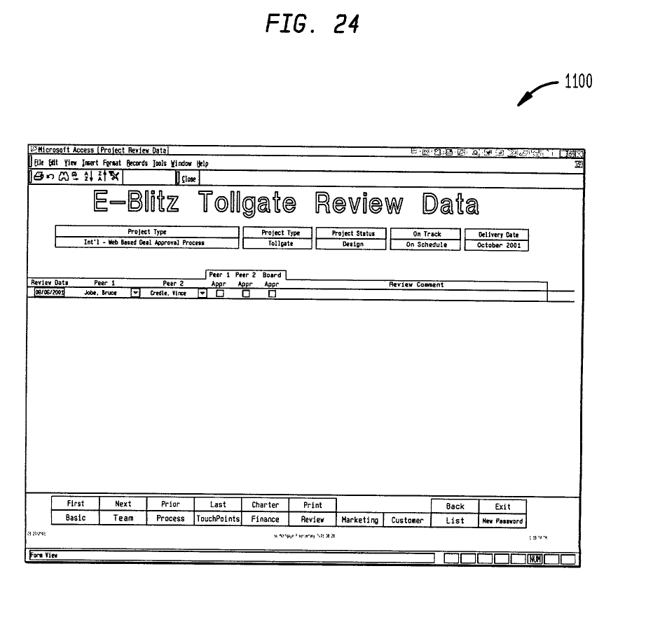

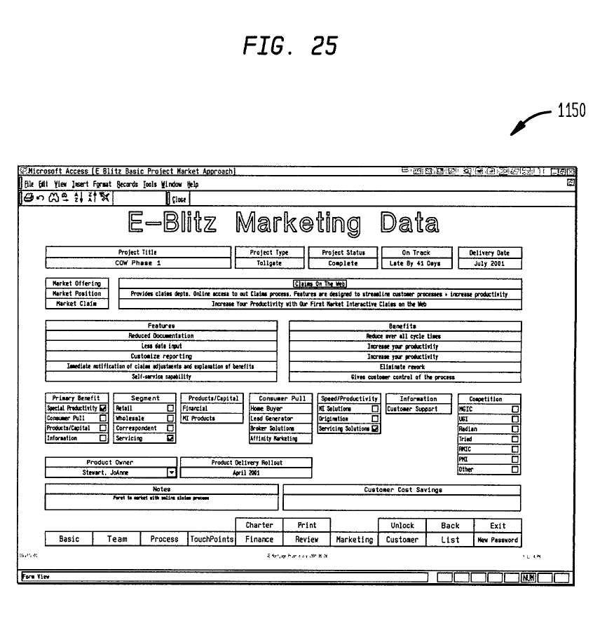

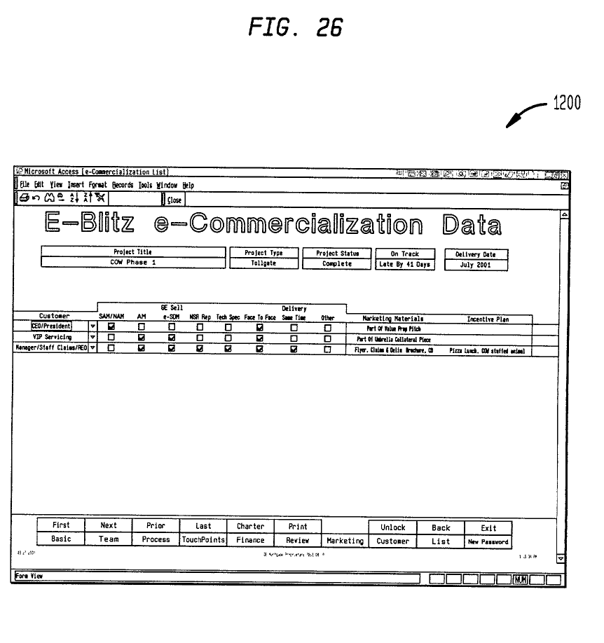

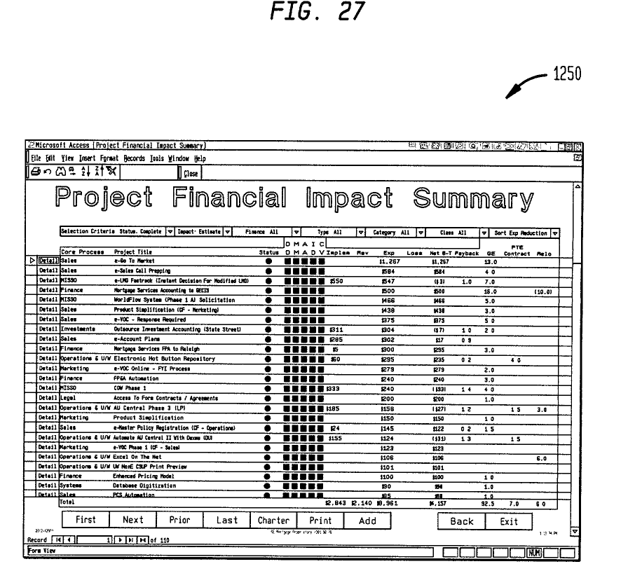

At the bottom of the basic data screen 850 shown in FIG. 19 is a row of buttons 852-864. These buttons are used to access various data screens showing different data relating to the identified project, including: a team data screen 900, shown in FIG. 20; a process data screen 950, shown in FIG. 21; a touchpoint data screen 1000, shown in FIG. 22; a finance/FTE summary screen 1050, shown in FIG. 23; a tollgate review data screen 1100, shown in FIG. 24; a marketing data screen 1150, shown in FIG. 25; and an e-commercialization data screen 1200, shown in FIG. 26 FIG. 27 shows a project financial impact summary screen 1250 according to an aspect of the invention. This screen is accessed by clicking on the Project List by Financial Impact button on the full main menu screen 550 shown in FIG. 13.

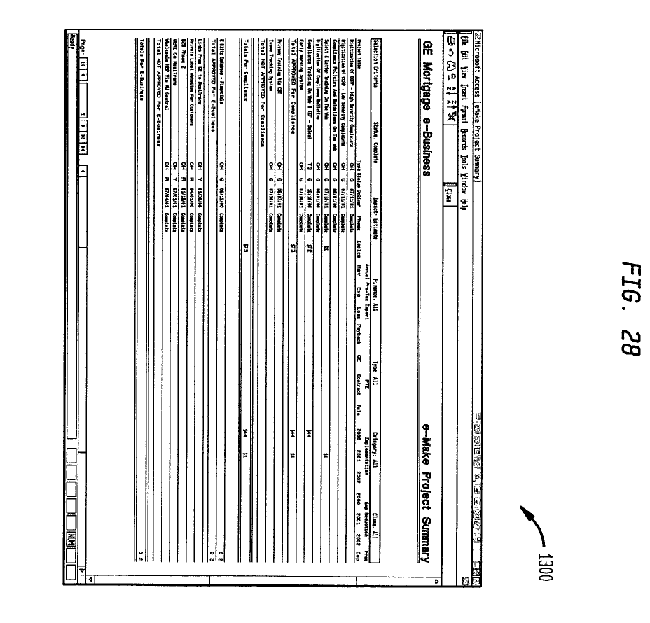

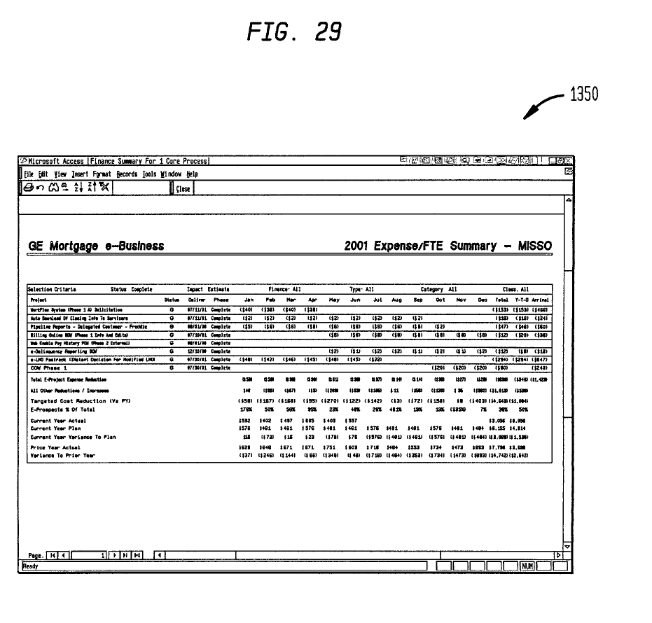

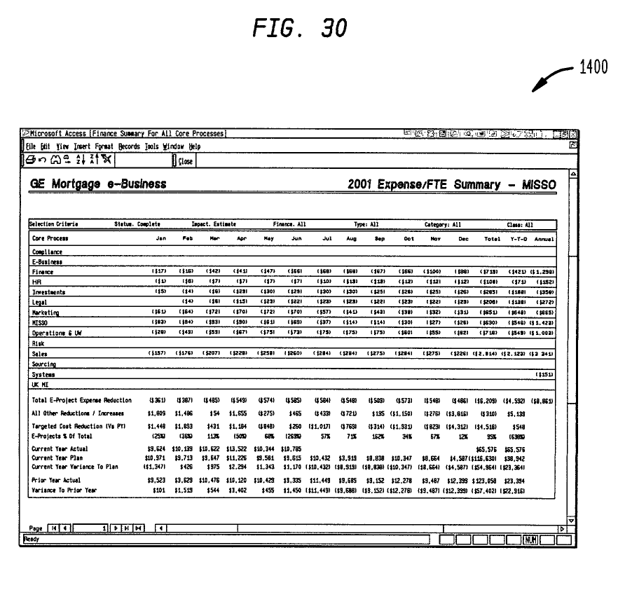

FIGS. 28, 29, and 30 show screens that are accessed by making a selection under the Finance heading on the full main menu screen 550 shown in FIG. 13. These menu selections are not available on the basic main menu screen 500 shown in FIG. 12. FIG. 28 shows a project summary screen 1300, which is accessed by selecting e-Make™ Summary Report. This screen 1300 shows cumulative data for e-Make™ projects entered into the system. FIG. 29 shows an expense/FTE summary screen 1350 for a single core process, namely, MISSO. This screen 1350 is accessed by selecting Finance/FTE Report (1 Process), and shows data for listed e-Make™ projects that have been identified for the single core process. FIG. 30 shows an expense FTE summary screen 1400 for all core processes. This screen 1400 is accessed by selected Finance/FTE Report (All Processes), and shows cumulative data for each listed core process.

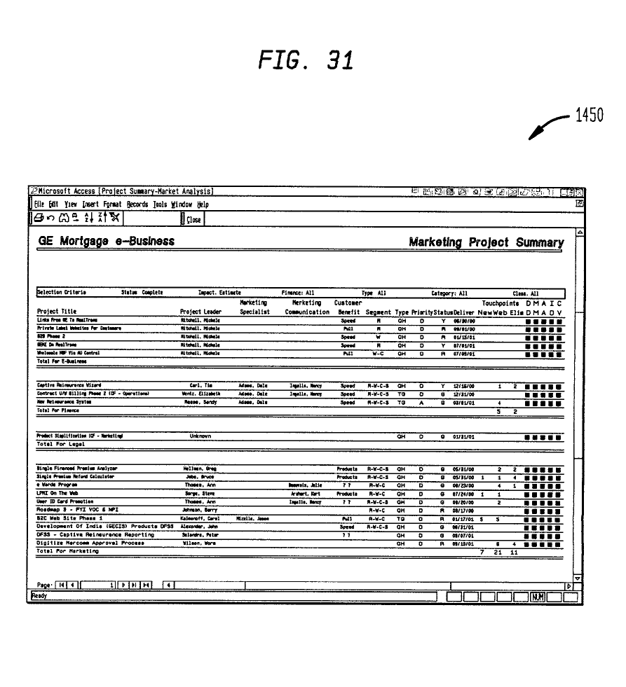

FIG. 31 shows a marketing project summary screen 1450, which is accessed by selecting Marketing Summary Report under the heading Marketing on the basic main menu screen 500 shown in FIG. 12 and the full main menu screen 550 shown in FIG. 12.

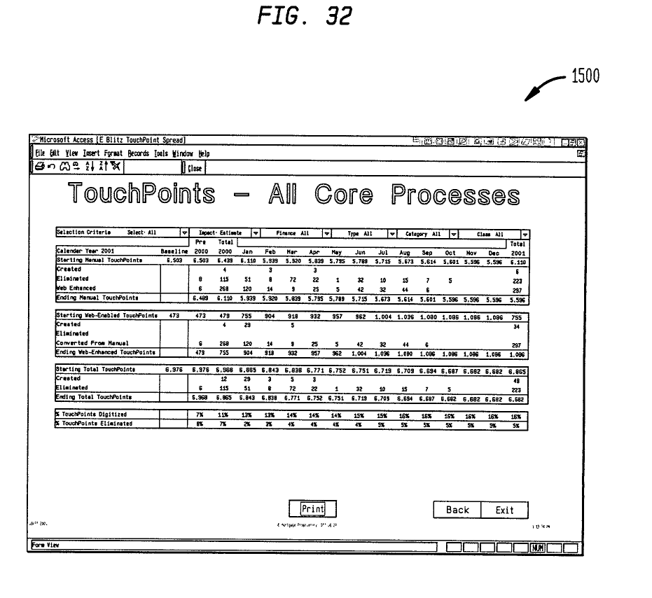

FIG. 32 shows a touchpoints —all core processes screen 1500, which is accessed by selecting TouchPoint Summary (All Processes) under the heading TouchPoints on the basic and full main menu screens.

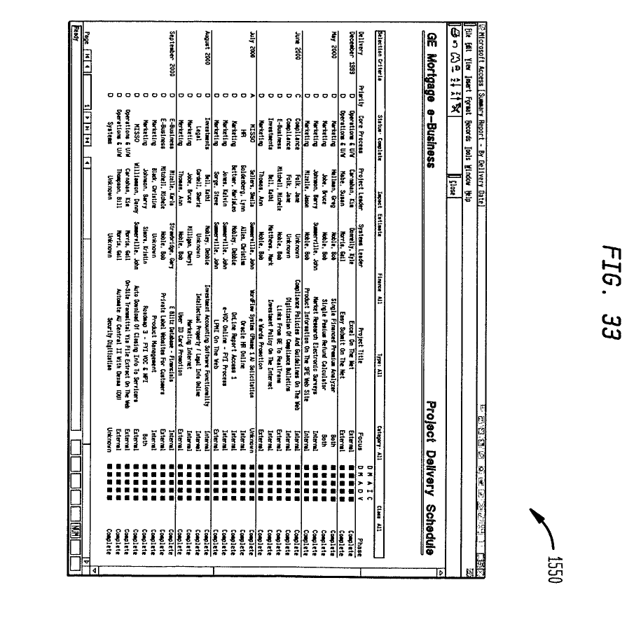

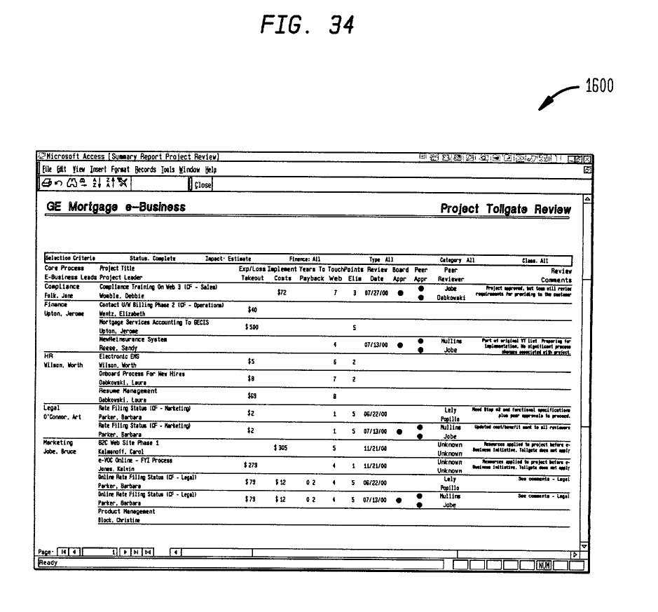

FIGS. 33 and 34 show screens that are accessed by making a menu selection under the heading Timeliness on the basic and full main menu screens. FIG. 33 shows a project delivery schedule screen 1550, which is accessed by selecting Project Report by Delivery Date. FIG. 34 shows a project tollgate review screen 1600, which is accessed by selecting Project Tollgate Report.

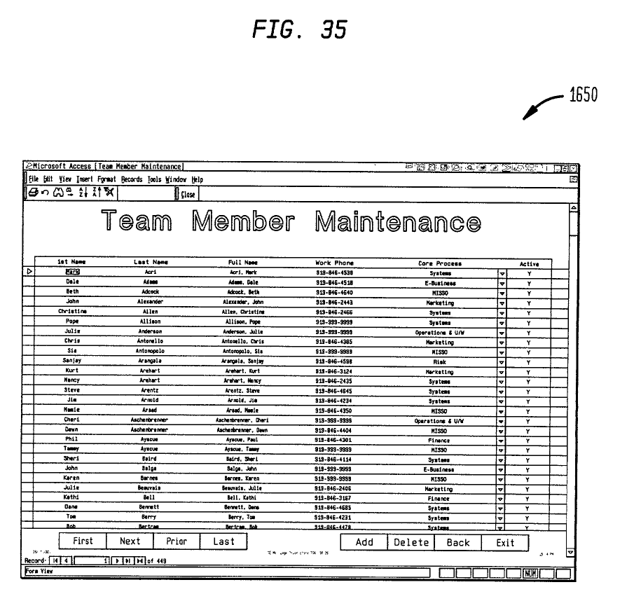

FIGS. 35 through 41 show screens that are accessed by making a menu selection under the heading Maintenance on the basic and full main menu screens. Only the team member maintenance screen 1650 shown in FIG. 35 is accessible from the basic main menu screen 500 shown in FIG. 12. All of the screens shown in FIGS. 35 through 41 are accessible from the full main menu screen 550 shown in FIG. 13.

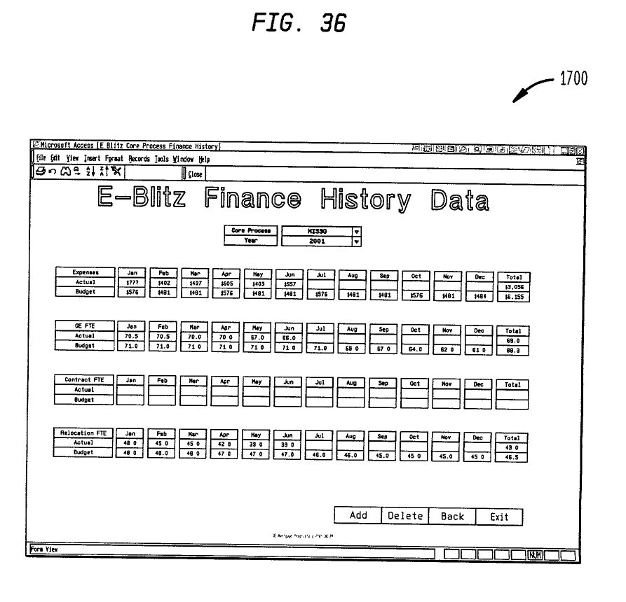

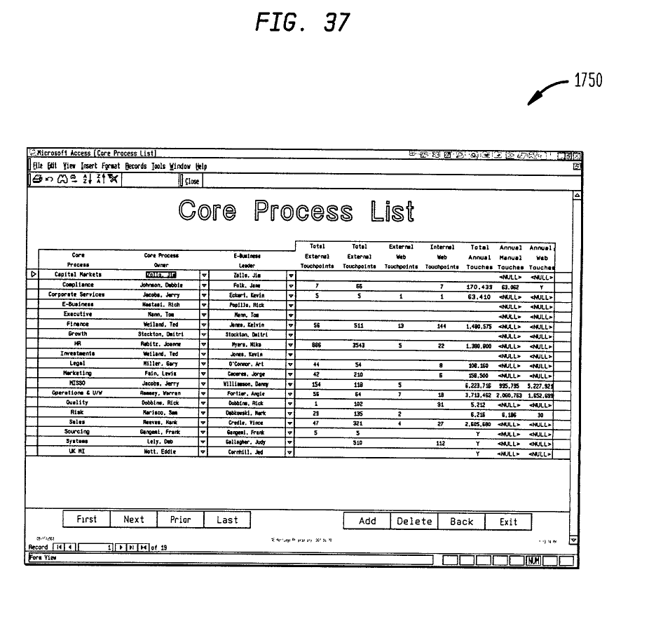

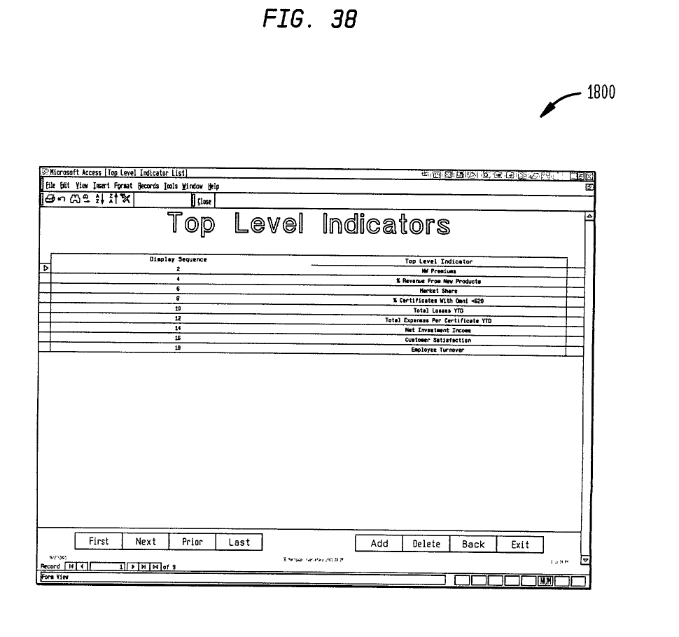

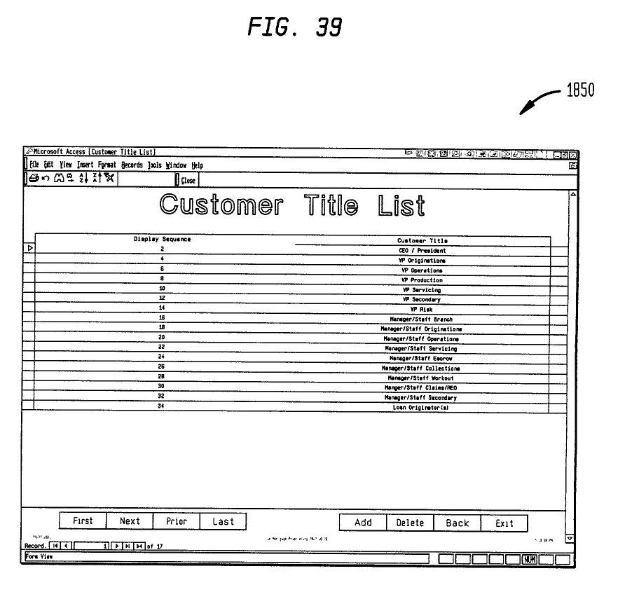

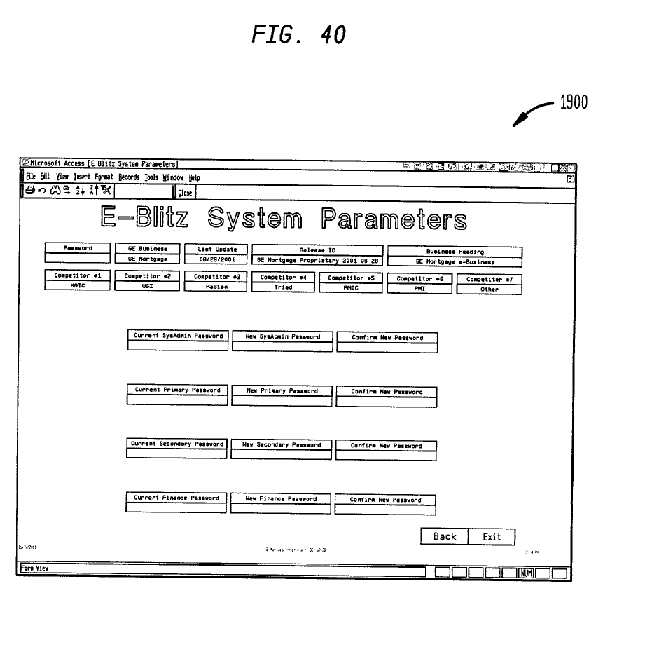

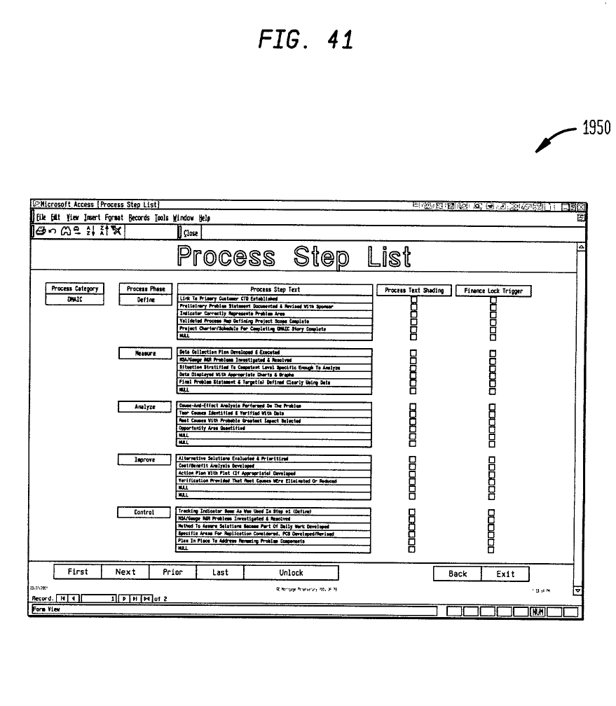

FIG. 35 shows a team member maintenance screen 1650, which is accessed by selecting Maintain Team Members. FIG. 36 shows a finance history data screen 1700, which is accessed by selecting Maintain Finance/FTE History. FIG. 37 shows a core process list 1750, which is accessed by selecting Maintain Core Processes. FIG. 38 shows a top level indicators screen 1800, which is accessed by selecting Maintain Top Level. FIG. 39 shows a customer title list screen 1850, which is accessed by selecting Maintain Customer Titles. FIG. 40 shows a system parameters screen 1900, which is accessed by selecting Maintain System Parameters. Finally, FIG. 41 shows a process step list screen 1950, which is accessed by selecting Maintain Process Steps.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

We claim:

1. A method for increasing productivity of a business organization and customer satisfaction, comprising:
(a) identifying and making an inventory of touchpoints;
(b) identifying projects, based upon the inventory of touchpoints;
(c) validating and prioritizing projects based on an analysis of customers' critical requirements and overall financial impact on the business organization;
(d) rigorously executing the prioritized projects; and
(e) measuring increases in productivity and customer satisfaction.

2. The method of claim 1, further including:
designating an employee to be a core process owner, who is accountable for steps (a) through (e).

3. The method of claim 1, wherein step (a) further comprises:
entering identified touchpoints into a table;
listing modes of communication used to effect each identified touchpoints.

4. The method of claim 3, wherein step (b) further comprises:
analyzing the inventory of touchpoints and the modes of communications used to effect each touchpoint; and
identifying projects that eliminate touchpoints.

5. The method of claim 3, wherein step (b) further comprises:
analyzing the inventory of touchpoints and the modes of communications used to effect each touchpoint;
classifying touchpoints as web-enabled and non-web-enabled; and
identifying projects that convert non-web-enabled touchpoints into web-enabled touchpoints.

6. The method of claim 1, wherein step (c) further comprises:
segmenting a customer base according to modes of distribution;
for each customer segment, constructing a business model and a set of business goals; and
identifying customer needs that are critical to quality.

7. The method of claim 6, wherein step (c) further comprises:
validating identified projects against the identified customer needs that are critical to quality.

8. The method of claim 6, wherein step (c) further comprises:
developing a list of top level indicators based upon identified customer needs that are critical to quality;
assigning weights to each top level indicator;
for each identified project, determining a numerical quantity indicating the relationship strength between the identified project and each top level indicator; and
using the assigned weights and the relationship strengths to calculate a score for each identified project.

9. The method of claim 6, wherein step (c) further comprises:
placing each identified project into a high priority matrix to maximize return on effort.

10. The method of claim 6, wherein step (c) further comprises:
ranking the identified projects in order of priority.

11. A method for increasing productivity of a business organization and customer satisfaction, comprising:
(a) identifying core processes of the business organization;
(b) designating employees of the business organization to be core process owners, who are accountable for increasing business productivity and customer satisfaction;
(c) identifying and making an inventory of touchpoints;
(d) identifying projects, based upon the inventory of touchpoints, to increase business productivity and customer satisfaction by eliminating or redesigning identified touchpoints;
(e) validating and prioritizing projects based upon an analysis of customers' critical requirements and overall financial impact on the business organization;
(f) rigorously executing the prioritized projects; and
(g) measuring increases in productivity and customer satisfaction.

12. The method of claim 1, wherein step (c) further comprises:
entering identified touchpoints into a table;
listing modes of communication used to effect each touchpoint; and
classifying touchpoints as web-enabled and non-web-enabled.

13. The method of claim 12, wherein step (d) further comprises:
identifying project that convert non-web-enabled touchpoints into web-enabled touchpoints.

14. The method of claim 11, wherein step (e) further comprises:
developing a list of top level indicators based upon identified customer needs that are critical to quality;
assigning weights to each top level indicator;
for each identified project, determining a numerical quantity indicating the relationship strength between the identified project and each top level indicator; and
using the assigned weights and the relationship strengths to calculate a score for each identified project.

15. The method of claim 14, wherein step (e) further comprises:
placing each identified project into a high priority matrix to maximize return on effort.

16. A system for increasing business productivity and customer satisfaction, comprising:
a server computer;
a network of terminals connected to the server, the server computer transmitting web pages to the terminals for providing outputs to, and receiving inputs from, the terminals;
an electronic database, accessible by the server computer, containing data relating to projects that have been identified by identifying and cataloguing touchpoints, and that have been validated against customer needs that are critical to quality,
the data in the database being presented at each terminal in web pages having varying levels of detail.

17. The system of claim 16, wherein data is presented as a series of drilldown screens, including:
a core processes screen, listing identified core processes;
an individual core process screen, accessible from the core processes screen, listing projects that have been identified for an individual core process; and
a project screen, accessible from the individual core process screen, displaying data relating to an individual project.
